(19) United States
(12) Patent Application Publication
(10) Pub. No.: US 2026/0175463 A1
(43) Pub. Date: Jun. 25, 2026

(54) OUTDOOR TOOL AND LUBRICATION SYSTEM

(71) Applicant: Techtronic Cordless GP, Anderson, SC (US)

(72) Inventors: Scott W. Reed, Anderson, SC (US); Christopher A. Holman, Clemson, SC (US)

(21) Appl. No.: 19/410,455

(22) Filed: Dec. 5, 2025

Related U.S. Application Data
(60) Provisional application No. 63/736,815, filed on Dec. 20, 2024.

(51) Int. Cl. B27B 17/12

(52) U.S. Cl. CPC B27B 17/12

(57) ABSTRACT

Outdoor tools and lubrication systems, including methods of operating the same, are provided. An outdoor tool or lubrication system includes a housing, a motor assembly attached to the housing, a tool unit, and a lubrication system. The tool unit may be powered by the motor assembly and include a guide bar and a chain circumscribing a portion of the guide bar. The lubrication system may provide lubricant to the chain. The lubrication system may include a lubricant reservoir attached to the housing to contain a volume of the lubricant, a lubricant output directed toward the guide bar in fluid communication with the lubricant reservoir, and a reversible lubricant pump disposed in fluid communication between the lubricant reservoir and the lubricant output to alternately motivate a first lubricant flow from the lubricant reservoir and a second lubricant flow to the lubricant reservoir.

### CROSS-REFERENCE TO RELATED APPLICATIONS

The present application claims priority to U.S. Provisional Application Serial No. 63/736,815 filed on December 20, 2024, the disclosure of which is incorporated by reference herein in its entirety.

### FIELD

The present disclosure relates generally to lubrication systems for outdoor power tools, e.g., chain saws, pole saws and the like.

### BACKGROUND

Outdoor tools, such as pole saws and handheld chainsaws, are used to perform outdoor tasks such as cutting tree branches and other vegetation. Pole saws and chainsaws cut through material using chains with cutting teeth. The chain is typically disposed in a track on a guide bar. The chain moves relative to the track, advancing the cutting teeth along the material being cut.

Frictional resistance between the chain and guide bar decreases saw efficiency. That is, the additional resistance between the chain and guide bar results in decreased energy capacity and fewer cuts which can be made between charging or refueling. To solve this problem, lubrication may be introduced between the chain and guide bar. However, too much lubrication can attract debris, interfere with electronic components of the tool, create a worse user experience, or even cause dripping. Even systems that are able to deliver a sufficient (and not excessive) volume of lubricant may be at risk for leaking lubricant when the tool is not in use, especially over time even if the tool is stored in an adequate position. For instance, gravity or pressure may cause lubricant within one or more portions of the system to slowly travel outside of the tool. Additionally or alternatively, existing tools or systems may be expensive, inefficient, difficult to assemble, or require significant space within the tool.

Accordingly, improved outdoor tool oiling systems are desired in the art. In particular, outdoor tools or lubrication systems that are able to hinder or prevent lubricant leakage would be advantageous. Additionally or alternatively, it may be useful to provide outdoor tools or lubrication systems that are able to provide sufficient lubrication while being relatively robust, energy efficient, or compact.

### BRIEF DESCRIPTION

Aspects and advantages of the present disclosure will be set forth in part in the following description, or may be obvious from the description, or may be learned through practice of the technology.

In accordance with one embodiment, a tool is provided. The tool includes a housing, a motor assembly attached to the housing, a tool unit, and a lubrication system. The tool unit may be powered by the motor assembly and include a guide bar and a chain circumscribing a portion of the guide bar. The lubrication system may provide lubricant to the chain. The lubrication system may include a lubricant reservoir attached to the housing to contain a volume of the lubricant, a lubricant output directed toward the guide bar in fluid communication with the lubricant reservoir, and a reversible lubricant pump disposed in fluid communication between the lubricant reservoir and the lubricant output to alternately motivate a first lubricant flow from the lubricant reservoir and a second lubricant flow to the lubricant reservoir.

In accordance with another embodiment, a method of operating a tool is provided. The method includes directing chain rotation at a motor assembly and motivating a first lubricant flow from the lubricant reservoir during chain rotation. The method further includes halting chain rotation and receiving a reversal signal when or following halting chain rotation. The method still further includes motivating a second lubricant flow to the lubricant reservoir in response to receiving the reversal signal.

In accordance with yet another embodiment, a lubrication system is provided. The system includes a lubricant reservoir, a lubricant output, one or more conduits, and a reversible lubricant pump. The lubricant reservoir may contain a volume of lubricant. The lubricant output may be directed toward the guide bar. The one or more conduits may define a lubricant flow path between the lubricant reservoir and the lubricant output. The reversible lubricant pump may be disposed in fluid communication between the lubricant reservoir and the lubricant output. The reversible lubricant pump may include a pump rotor to alternately motivate a first lubricant flow from the lubricant reservoir and a second lubricant flow to the lubricant reservoir.

These and other features, aspects and advantages of the present disclosure will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present application, including the best mode of making and using the present systems and methods, directed to one of ordinary skill in the art, is set forth in the specification, which makes reference to the appended figures, in which:

FIG. 1 is a perspective view of an outdoor tool in accordance with embodiments of the present disclosure;

FIG. 2 is a perspective view of a portion of the exemplary outdoor tool of FIG. 1, wherein a portion of a housing has been removed for clarity;

FIG. 3 is a front perspective view of a portion of an outdoor tool in accordance with embodiments of the present disclosure;

FIG. 4 is a rear perspective view of a portion of an outdoor tool in accordance with embodiments of the present disclosure;

FIG. 5 is a cross-sectional perspective view of a portion of an outdoor tool in accordance with embodiments of the present disclosure;

FIG. 6 is a schematic representation of operation of a lubrication system in accordance with embodiments of the present disclosure;

FIG. 7 is a flow chart of a method of operating an outdoor tool in accordance with embodiments of the present disclosure;

FIG. 8 is a perspective view of a portion of a lubrication system in accordance with embodiments of the present disclosure;

FIG. 9 is a perspective view of a portion of an outdoor tool in accordance with embodiments of the present disclosure;

FIG. 10 is a partially exploded perspective view of a housing and gear assembly of the exemplary outdoor tool of FIG. 9;

FIG. 11 is an exploded perspective view of the gear assembly of the exemplary outdoor tool of FIG. 9; and

FIG. 12 is a sectional view of the gear assembly of the exemplary outdoor tool of FIG. 9.

### DETAILED DESCRIPTION

Reference now will be made in detail to embodiments of the present disclosure, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the disclosure.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive- or and not to an exclusive- or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, aspects of the present disclosure provide an outdoor tool or lubrication system having a reversible lubricant pump that can flow lubricant to a guide bar and alternately away from the guide bar, thereby preventing lubricant from dripping from the outdoor tool or system, for example, during storage or non-use.

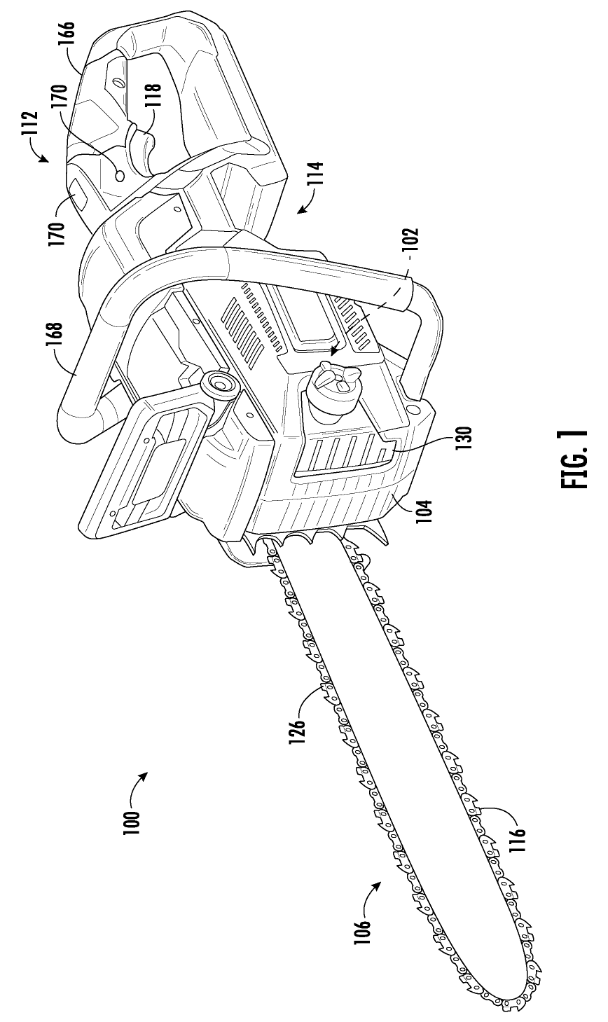

Referring now to the drawings, FIG. 1 illustrates a perspective view of a tool 100 in accordance with exemplary embodiments of the present disclosure. In particular, the tool 100 shown in FIG. 1 is a chain saw. The tool 100 has a lubrication system 102 disposed within a housing 104 of the tool 100. The tool 100 can further include a guide bar assembly or tool unit 106 including a guide bar 116 that receives a chain 126, e.g., circumscribed around the guide bar 116. As will be described in greater detail below, the tool 100 may further include a motor assembly 110 and lubrication system 102 (e.g., within the housing 104). When assembled, one or more hoses or conduits connected to the lubrication system 102 may generally direct or deliver liquid lubricant (e.g., lubricant oil) from the lubrication system 102 to the guide bar assembly 106.

The tool 100 can include a variety of features and configurations to facilitate the handling and operation of the tool 100 by a user. For instance, the housing 104 may include a first handle 166 (e.g., a rear handle) coupled between a battery pack receptacle or receiver 114 and a front portion of the housing 104. As such, the first handle 166 extends in a direction along the longitudinal axis of the guide bar 116. In addition, the housing 104 includes a second handle 168 (e.g., an elongated curved bar; front handle) coupled between the first handle 166 and a sidewall of the battery pack receptacle 114.

A user interface, e.g., a trigger 118, can be disposed at a location whereby an operator can control operation of the tool 100, such as on the first handle 136. The trigger 118 can control the motor assembly 110 of the tool 100 to drive the chain 126 along the guide bar 116. By way of non-limiting example, the motor assembly 110 can include a motor having an output or drive shaft. The drive shaft can be in communication with the chain 126, e.g., through a transmission having a drive sprocket 124, so as to move the chain 126 along the guide bar 116. For instance, the drive sprocket 124 may be rotatably coupled to the transmission, and the chain 126 may be in operable communication with the drive sprocket 124 (e.g., the chain 126 may circumscribe a portion of the drive sprocket 124) such that the drive sprocket 124 can drive the chain 126 about the guide bar 116. When the trigger 118 is activated, e.g., depressed, the speed of the motor assembly 110 can increase. Conversely, when the trigger 118 is deactivated, e.g., not depressed, the motor assembly 110 can stop.

The motor assembly 110 may include or be provided as any generational source of power to directly, or indirectly, move the chain 126 around the guide bar 116, such as an electric motor or internal combustion engine. Optionally, the motor assembly 110 may be a variable speed motor and a relative activated position of the trigger 118 can inform the speed of the variable speed motor. That is, the operator can control the speed of the chain 126 along the guide bar 116 based on how far the trigger 118 is depressed. One or more secondary user interfaces, e.g., a power button or lubricant reversal user input, can be used to control another aspect of the tool 100. A power button can include, for example, a toggle which can be moved between ON and OFF positions. The tool 100 may not function when the power button is in the OFF position and the ON/OFF toggle may be biased to the OFF position such that a user must hold the toggle in the ON position while simultaneously depressing the trigger 118 to engage the motor assembly 110. Alternatively, the ON/OFF toggle can function as an interlock that prevents depression of the trigger 118 unless held in the ON position. Additionally or alternatively, an oil-pump button can include, for example, a depressible button or switch that can activate or initiate a function of the lubrication system 102 (e.g., as will be described below).

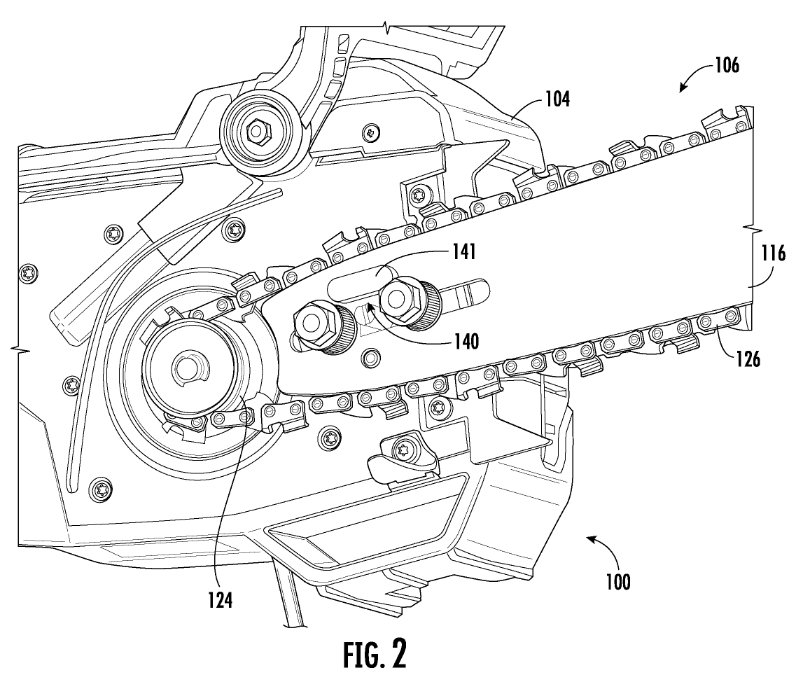

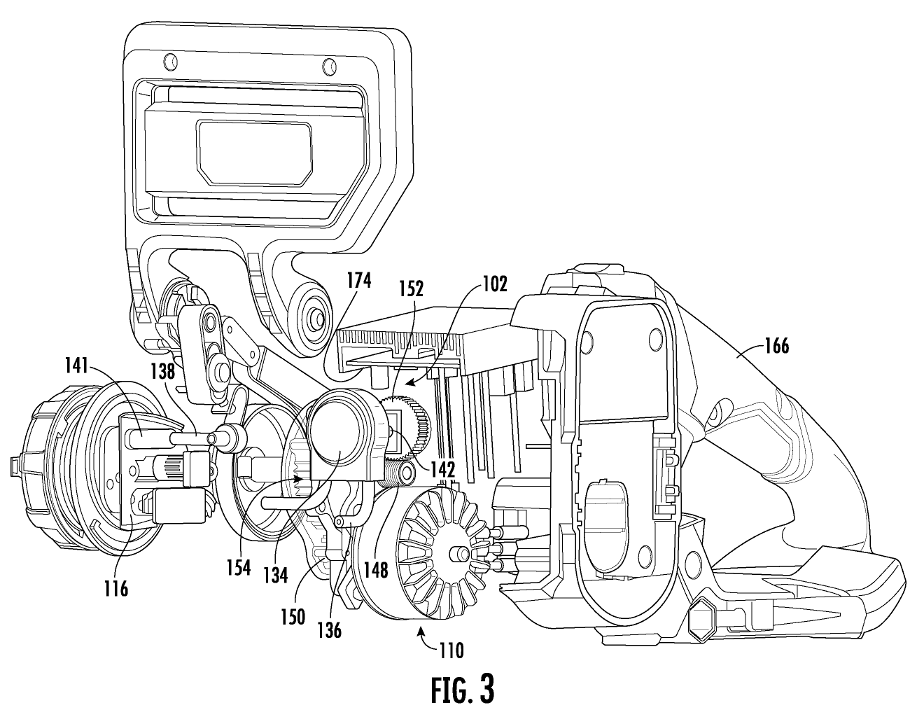

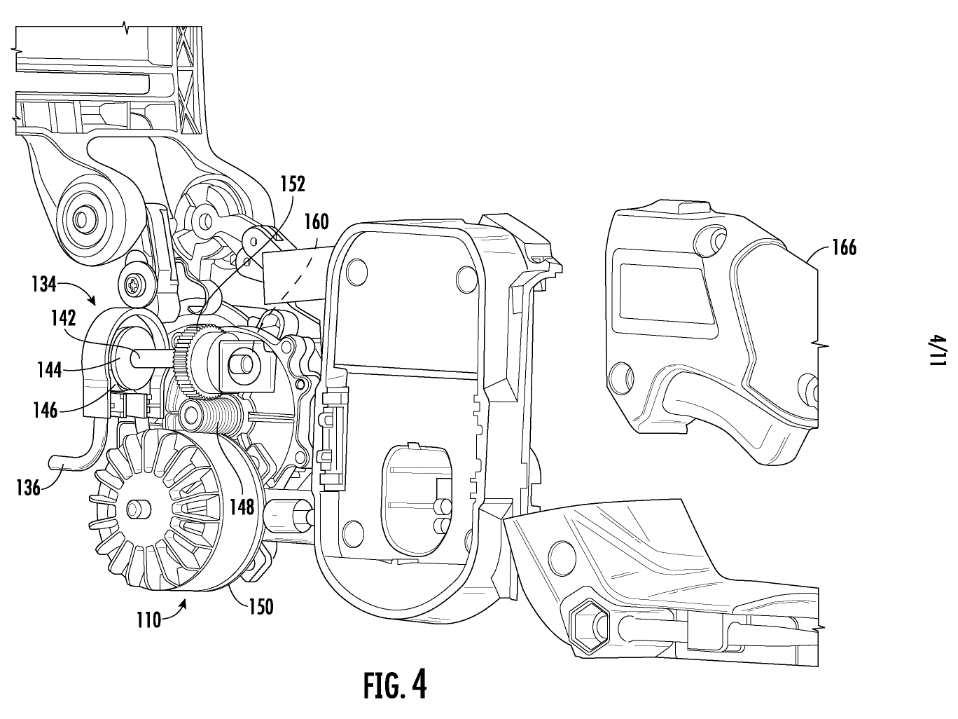

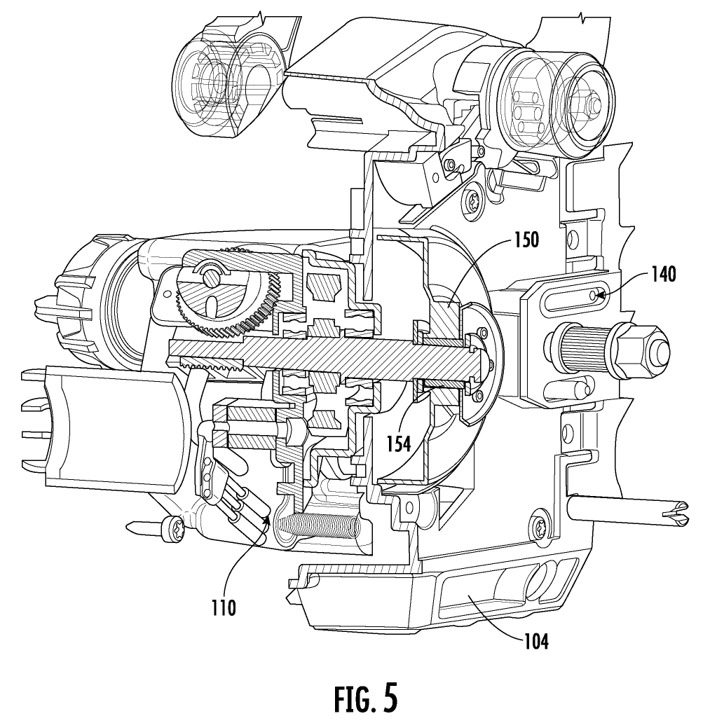

Turning now generally to FIGS. 2 through 6, various views are provided to illustrate a lubrication system 102, and aspects of the same, according to exemplary embodiments. Generally, the lubrication system 102 includes a lubricant reservoir 130 configured to house a lubricant. One or more conduits (e.g., first hose 136 or second hose 138) may be provided to fluidly connect the lubricant reservoir 130 to a lubricant output (e.g., oil outlet port 140) provided at a location adjacent to the guide bar 116 or chain 126. Thus, the one or more conduits may define a flow path for lubricant between lubricant reservoir 130 and lubricant output 140. It is noted that although the hoses 136, 138 are rendered as separate, spaced-apart conduits (e.g., such that it appears in FIGS. 3 and 4 that a gap exists between the hoses), it would be understood that the assembled tool 100 would provide hoses 136, 138 in a continuous or connected arrangement such that liquid lubricants or oil could flow continuously between first hose 136 and second hose 138. In other words, the hoses 136, 138 may be connected or unitary such that the fluid flow path between the hoses 136, 138 is uninterrupted.

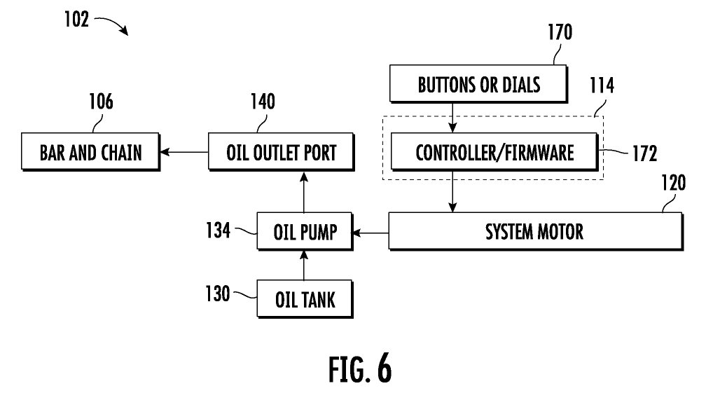

A reversible lubricant pump 134 may be disposed in fluid communication between the lubricant reservoir 130 and the lubricant output 140 to drive, pump, or otherwise motivate lubricant (e.g., through or along the conduit(s) 136, 138). For instance, reversible lubricant pump 134 may be mounted within housing 104, such as above motor assembly 110. As will be described in greater detail below, reversible pump 134 may be driven to alternately flow lubricant in opposite fluid-flow directions between the lubricant reservoir 130 and the lubricant output 140. Thus, under certain conditions, reversible pump 134 may motivate a first lubricant flow from the lubricant reservoir 130 (e.g., toward the output 140 such that the output 140 is downstream from the lubricant reservoir 130 or reversible pump 134). Under other or alternated conditions, reversible pump 134 may reverse lubricant flow along the flow path to motivate a second lubricant flow to or toward the lubricant reservoir 130 (e.g., away from output 140 such that lubricant reservoir 130 is downstream from output 140 or reversible pump 134). A system motor 120 (FIG. 6) (e.g., including or provided as motor assembly 110 or, alternatively, as a separate and discrete electric pump motor 160) may be attached to or included with reversible pump 134 to drive rotation thereof.

In some embodiments, a lubricant dispenser 141 is provided at or otherwise to define the oil outlet port 140. The lubricant dispenser 141 may be configured to receive lubricant from the reservoir 130 through the reversible pump 134 and one or more conduits (e.g., in the first lubricant flow, such as described above). At or during the first lubricant flow, the lubricant dispenser 141 may receive lubricant that is provided from the conduit(s) 136, 138 to the guide bar 116, the chain 126, or combinations thereof, or receive an excess amount of lubricant that is provided from the conduit(s) 136, 138. In other embodiments, the lubricant dispenser 141 may form a guide track through which the guide bar 116 is extended. At or during the first lubricant flow, the lubricant dispenser 141 may receive lubricant from the conduit(s) 136, 138 and provide surfaces at which the lubricant can build up and be received at the guide bar 116 or the chain 126.

Turning especially to FIGS. 3 through 5, the reversible lubricant pump 134 or system 102 generally may include a pump rotor 144. As shown, the pump rotor 144 may be rotatably disposed along the lubricant flow path (e.g., to alternately motivate the first lubricant flow and the second lubricant flow). A drive shaft 142 may be attached to pump rotor 144 and extend along an axial direction A (e.g., which defines an axis of rotation for reversible lubricant pump 134). Pump rotor 144 may be fixed to drive shaft 142 and, thus, rotate simultaneously to or in concert with drive shaft 142 about the axial direction A. Thus, drive shaft 142 and pump rotor 144 may be coaxial.

In the illustrated embodiments, pump rotor 144 includes or is provided as a peristaltic rotor disposed outside of the lubricant flow path on the one or more conduits 136, 138. A set of rollers 146 may be provided with the peristaltic rotor to roll along an outer surface of the one or more conduits while being rotated (e.g., clockwise and, alternately, counterclockwise about the axial direction) with the pump rotor 144 to motivate fluid flow, such as would be understood in light of the present disclosure.

It is noted that while that illustrated reversible lubricant pump 134 with a pump rotor 144 is illustrated as including a peristaltic rotor, alternative embodiments may be provided with or as any suitable pump. For instance, lubricant pump 134 or pump rotor 144 may include or be provided as a diaphragm pump or a pair of discrete pumps (e.g., a first pump configured to motivate lubricant in the first direction and a second pump configured to motivate lubricant in the second direction).

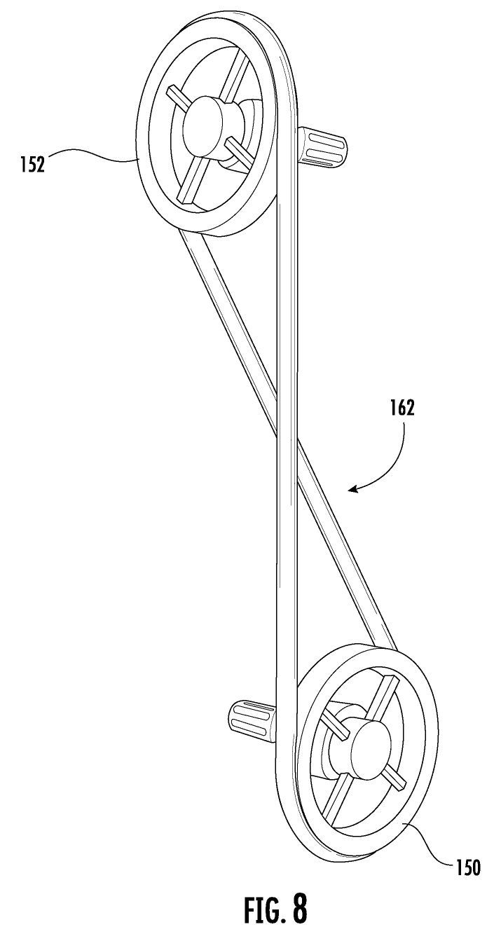

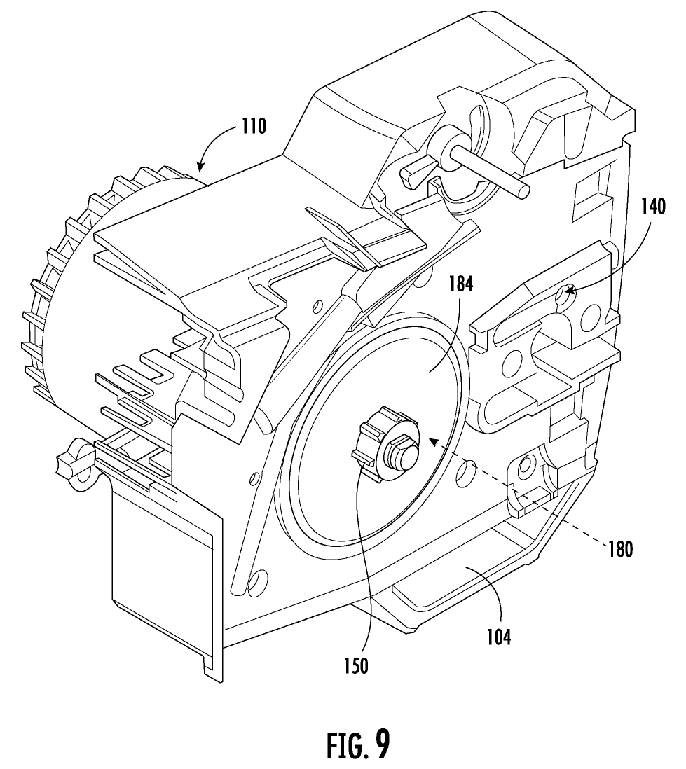

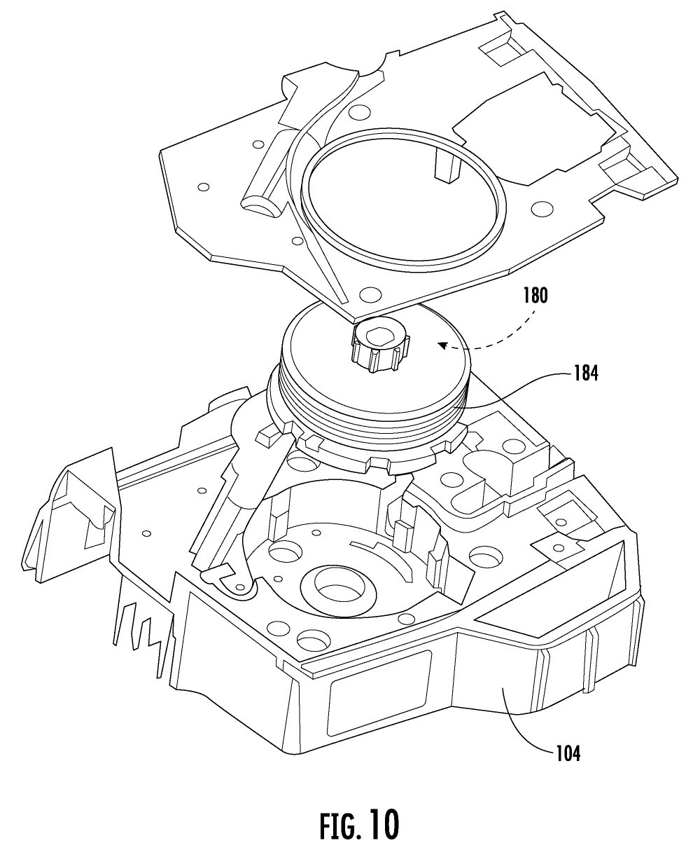

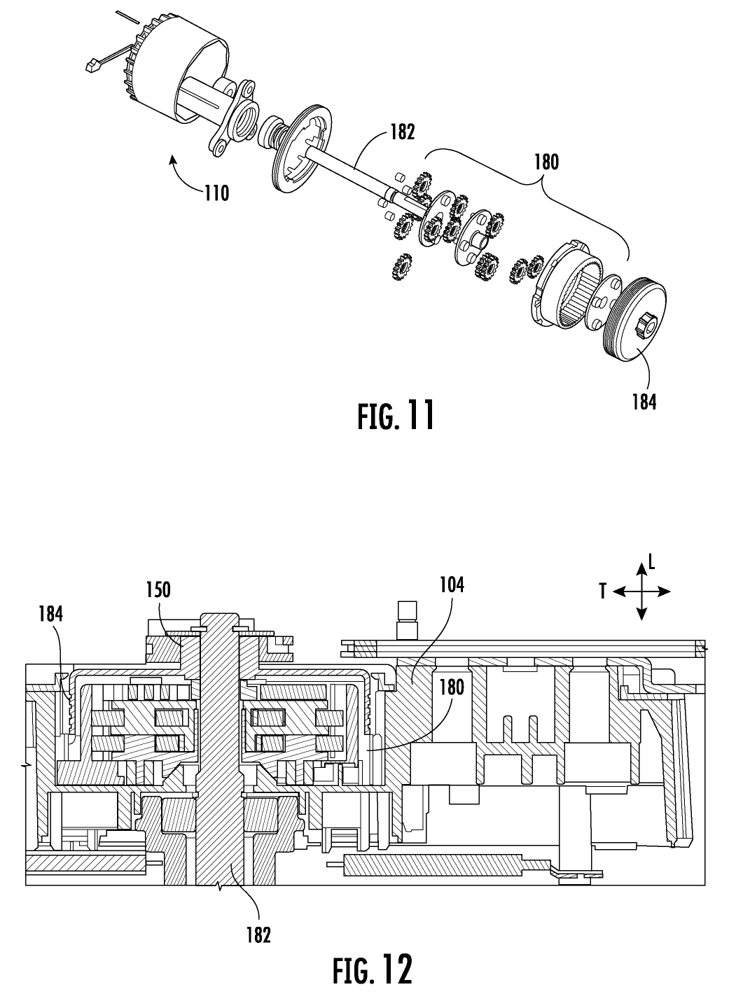

In certain embodiments, the pump rotor 144 is in mechanical communication with the motor assembly 110. Specifically, the motor assembly 110 may be included with or provided as system motor 120 to drive rotation of the pump rotor 144. In some such embodiments, a gear train (e.g., including gear assembly 180—FIGS. 9 through 12) including one or more gears, pulleys, cams, or levers is provided to mechanically link or connect motor assembly 110 with pump rotor 144. Such gear trains may include a planetary gear assembly or stack of compound gears (e.g., to provide a gear reduction for output) or one or more bevel gears (e.g., such that the axis of the motor assembly 110 is angled or nonparallel to the axis of the pump rotor 144). Thus, rotation of the motor assembly 110 may be transferred, at least in part, to pump rotor 144. As an example, an intermediate worm gear 148 may be disposed in mechanical communication between the motor assembly 110 and the pump rotor 144. When assembled, the intermediate worm gear 148 may be in mechanical communication (e.g., enmeshed) with a drive gear 150 (e.g., toothed gear) on the motor assembly 110 (e.g., apart from drive sprocket 124—FIG. 2) and a separate driven gear 152 (e.g., toothed gear). As another example, and turning briefly to FIG. 8, an intermediate belt assembly 162 may be disposed in mechanical communication between the motor assembly 110 and the pump rotor 144 (FIG. 3). As shown, the continuous belt of the intermediate belt assembly 162 may connect a pair of separate pulleys that may be disposed at separate (e.g., nonparallel or parallel) axes of rotation. For instance, the intermediate belt assembly 162 may be looped around or otherwise establish mechanical communication with the drive gear 150 (e.g., pulley gear) and the driven gear 152 (e.g., pulley gear).

As shown, particularly in FIGS. 3 through 5, the driven gear 152 may be fixed to the drive shaft 142 (e.g., apart from the pump rotor 144) to rotate therewith. Rotation of the motor assembly 110 may be reversible to selectively alternate rotation of the pump rotor 144. Thus, motor assembly 110 may include a reversible motor. It is noted that in certain embodiments, a one-way ratchet 154 (e.g., one-way bearings, sprag clutches, or other one way devices that could potentially be used to accomplish uni-directional drive of the chain) is provided in mechanical communication between the motor assembly 110 and the tool unit 106 (e.g., mechanically downstream or spaced apart from drive gear 150). For instance, the one-way ratchet 154 may be included with the transmission of the motor assembly 110 to maintain uni-directional rotation of the chain 126 (FIG. 2). The uni-directional rotation of the chain 126 may correspond with the first lubrication flow of the lubrication system 102. Thus, rotation of the motor assembly 110 to induce or drive rotation of the chain 126 may simultaneously motivate the first lubrication flow. By contrast, reversed rotation of the motor assembly 110 to motivate the second lubrication flow may be prevented from inducing or driving rotation of the chain 126.

Turning briefly to FIGS. 9 through 12, as noted above, a gear train, such as gear assembly 180 may be provided to mechanically link or connect motor assembly 110 with pump rotor 144 (FIG. 4). In some such embodiments, a drive shaft 182 extending from or as part of motor assembly 110 extends through at least a portion of gear assembly 180 (e.g., to drive rotation thereof). In the illustrated embodiments, gear assembly 180 includes a planetary gear set (e.g., 3-stage planetary gear set). As shown, the gear assembly 180 may reduce along the transfer path going back towards the motor assembly 110. Additionally or alternatively, all or a portion of gear assembly 180 may be disposed beneath or contained within a portion of the brake assembly (e.g., the brake drum 184, which may have an outer surface or perimeter against which a brake band may selectively engage), which would otherwise be understood in light of the present disclosure. In certain embodiments, pump rotor 144 (e.g., including corresponding tubing and rollers) may be mounted behind gear assembly 180 (e.g., between the last stage of gears in gear assembly 180 and at least a portion of motor assembly 110 along the lateral direction L). Notably, a compact or space-efficient gear train or motor assembly may be provided within the housing 104.

It is noted that although pump rotor 144 may be in mechanical communication with the motor assembly 110 in certain embodiments, additional or alternative embodiments may provide a separate pump motor 160 spaced apart from the motor assembly 110 and in mechanical motivation with the pump rotor 144 to drive rotation thereof. Thus, the pump motor 160 may be included with or provided as system motor 120 to drive rotation of the pump rotor 144.

FIG. 6 shows a schematic representation of the operation of the lubrication system 102. The pump 134 may be operated, e.g., controlled and actuated, by the system motor 120. The tool 100 has a control assembly 112 that includes one or more inputs such as buttons or dials to control operation of the tool 100, including but not limited to the trigger 118 or input(s) 170. The control assembly 112 includes a controller 174, e.g., a printed circuit board (PCB) or other hardware and firmware, which can receive an input from the input(s) 170. The controller 174 is operatively coupled to (i.e., in operable communication with) system motor 120 to control the positive displacement pump 134 simultaneously with system motor 120. The system motor 120 may be electrically driven by the controller 174 to cause rotation of the system motor 120 in a first direction and, alternately, in a second direction. For instance, when the motor assembly 110 is driven by the controller 174 to rotate in the first direction, the pump 134 is actuated (e.g., by the pump rotor 144—FIG. 4) to pump lubricant from the lubricant reservoir 130 to the lubricant output 140, thereby delivering lubricant to the bar and chain 126 assembly 106. Moreover, when the motor assembly 110 is driven by the controller 174 to rotate in the second direction, the pump 134 is actuated (e.g., by the pump rotor 144) to generate negative pressure along the lubricant flow path. Negative pressure may also cause the lubrication system to unprime, i.e., to pull lubricant backwards through the lines towards the reservoir 130. By unpriming the lubrication system due to negative pressure, lubricant is drawn away from the output 140 and towards the reservoir 130, thereby yielding less leakage of lubricant, for example, during storage or non-use.

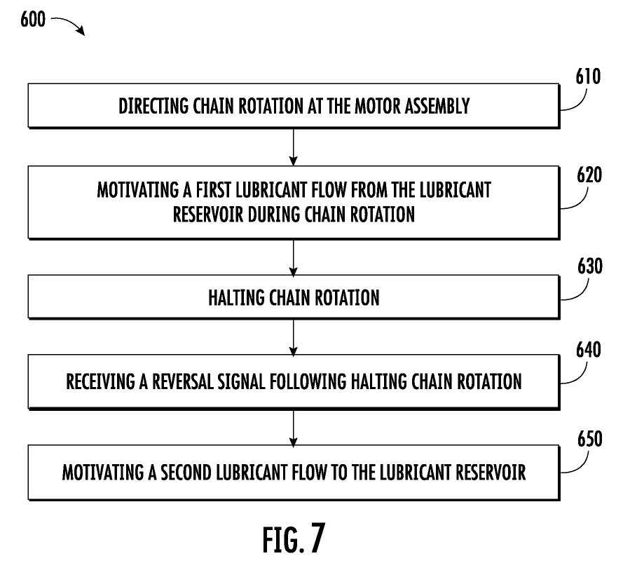

FIG. 7 illustrates a flow chart of a method 600 of operating a tool (e.g., as part of an oil-retention operation) in accordance with an embodiment. In general, the method 600 will be described with reference to a system including the tool 100 and associated equipment as described above with reference to FIGS. 1 through 6. One or more steps below may be performed, for instance, by controller 174. In addition, although FIG. 7 depicts steps performed in a particular order for purposes of illustration and discussion, the method discussed herein is not limited to any particular order or arrangement. One skilled in the art, using the disclosure provided herein, will appreciate that various steps of the method disclosed herein can be omitted, rearranged, combined, or adapted in various ways without deviating from the scope of the present disclosure.

At 610, the method 600 includes directing chain rotation at the motor assembly. For instance, the motor assembly may be directed to rotate (e.g., in the first direction) to drive rotation of the chain. Such rotation may be in response to any suitable input, such as at engagement of the trigger, as would be understood.

At 620, the method 600 includes motivating the first lubricant flow during chain rotation. In other words, during 610, the lubrication system may be directed to motivate lubricant toward the guide bar or chain. Specifically, the reversible pump may be activated or driven to motivate the first lubricant flow, as described above. In some such embodiments, the first lubricant flow is driven or prompted via the motor assembly. In other words, rotation of the motor assembly may cause the reversible lubricant pump to rotate (e.g., according to the direction for the first lubricant flow). In alternative embodiments, the first lubricant flow is driven or prompted via a dedicated pump motor. In other words, separate from the motor assembly, the pump motor may cause the reversible lubricant pump to rotate (e.g., according to the direction for the first lubricant flow).

At 630, the method 600 includes halting chain rotation. In particular, rotation of the motor assembly may be halted following 610 or 620. Such rotation may be in response to any suitable input (or lack of active input), such as at the release of the trigger, as would be understood.

At 640, the method 600 includes receiving a reversal signal when or following halting chain rotation. Optionally, the reversal signal may be received from a dedicated input, such as from the reversal user input. Thus, a user may press or engage the reversal user input to prompt the reversal signal. Alternatively, the reversal signal may be automatically prompted or directed in response to a separate tool action, such as 630. Thus, halting rotation of the chain may prompt the reversal signal without any other separate user input. In some such embodiments, 640 includes determining a minimum run time at 620 before prompting 640. Thus, rotation of the chain may be required for the minimum run time in order to prompt the reversal signal.

At 650, the method 600 includes motivating the second lubricant flow in response to receiving the reversal signal. In other words, in response to 640, the lubrication system may be directed to generate a negative pressure or otherwise motivate lubricant from the output or toward the reservoir. Specifically, the reversible pump may be activated or driven to motivate the second lubricant flow, as described above. In some such embodiments, the second lubricant flow is driven or prompted via the motor assembly. In other words, rotation of the motor assembly may cause the reversible lubricant pump to rotate (e.g., according to the direction for the second lubricant flow). In alternative embodiments, the second lubricant flow is driven or prompted via a dedicated pump motor. In other words, separate from the motor assembly, the pump motor may cause the reversible lubricant pump to rotate (e.g., according to the direction for the second lubricant flow).

Further aspects of the disclosure are provided by one or more of the following embodiments:

A tool comprising: a housing; a motor assembly attached to the housing; a tool unit powered by the motor assembly, the tool unit comprising a guide bar and a chain circumscribing a portion of the guide bar; and a lubrication system to provide lubricant to the chain, the lubrication system comprising: a lubricant reservoir to contain a volume of the lubricant, a lubricant output directed toward the guide bar in fluid communication with the lubricant reservoir, and a reversible lubricant pump disposed in fluid communication between the lubricant reservoir and the lubricant output to alternately motivate a first lubricant flow from the lubricant reservoir and a second lubricant flow to the lubricant reservoir.

The tool of any one or more of the embodiments, wherein the reversible lubricant pump is mounted above the motor assembly.

The tool of any one or more of the embodiments, wherein the lubrication system further comprises one or more conduits defining a lubricant flow path between the lubricant reservoir and the lubricant output, and a pump rotor rotatably disposed along the lubricant flow path to alternately motivate the first lubricant flow and the second lubricant flow.

The tool of any one or more of the embodiments, wherein the pump rotor comprises a peristaltic rotor disposed outside of the lubricant flow path on the one or more conduits.

The tool of any one or more of the embodiments, wherein the pump rotor is in mechanical communication with the motor assembly.

The tool of any one or more of the embodiments, further comprising a one-way ratchet in mechanical communication between the motor assembly and the tool unit to maintain uni-directional rotation of the chain.

The tool of any one or more of the embodiments, further comprising an intermediate worm gear disposed in mechanical communication between the motor assembly and the pump rotor.

The tool of any one or more of the embodiments, wherein the lubrication system further comprises a pump motor spaced apart from the motor assembly and in mechanical motivation with the pump rotor to drive rotation thereof.

The tool of any one or more of the embodiments, further comprising a controller in operable communication with the motor assembly and lubrication system and configured to direct an oil-retention operation, the oil-retention operation comprising: directing chain rotation at the motor assembly, motivating the first lubricant flow during chain rotation, halting chain rotation, receiving a reversal signal when or following halting chain rotation, and motivating the second lubricant flow in response to receiving the reversal signal.

The tool of any one or more of the embodiments, further comprising a reversal user input in operable communication with the controller and is supported on the housing apart from the motor assembly, wherein the reversal signal is received from the reversal user input.

The tool of any one or more of the embodiments, wherein the reversal signal is received in response to halting chain rotation.

A method of operating a tool comprising a motor assembly, a tool unit powered by the motor assembly, the tool unit comprising a guide bar and a chain circumscribing a portion of the guide bar, a lubricant reservoir, a lubricant output directed toward the guide bar in fluid communication with the lubricant reservoir, and a reversible lubricant pump disposed in fluid communication between the lubricant reservoir and the lubricant output, the method comprising: directing chain rotation at the motor assembly; motivating a first lubricant flow from the lubricant reservoir during chain rotation; halting chain rotation; receiving a reversal signal when or following halting chain rotation; and motivating a second lubricant flow to the lubricant reservoir in response to receiving the reversal signal.

The method of any one or more of the embodiments, wherein the tool further comprises a reversal user input in operable communication with the controller and is supported on the housing apart from the motor assembly, wherein the reversal signal is received from the reversal user input.

The method of any one or more of the embodiments, wherein the reversal signal is received in response to halting chain rotation.

A lubrication system of a tool comprising a guide bar and a chain circumscribing a portion of the guide bar, the lubrication system comprising: a lubricant reservoir to contain a volume of the lubricant; a lubricant output directed toward the guide bar; one or more conduits defining a lubricant flow path between the lubricant reservoir and the lubricant output; and a reversible lubricant pump disposed in fluid communication between the lubricant reservoir and the lubricant output, the reversible lubricant pump comprising a pump rotor to alternately motivate a first lubricant flow from the lubricant reservoir and a second lubricant flow to the lubricant reservoir.

The lubrication system of any one or more of the embodiments, wherein the pump rotor comprises a peristaltic rotor disposed outside of the lubricant flow path on the one or more conduits.

The lubrication system of any one or more of the embodiments, wherein the pump rotor is in mechanical communication with the motor assembly.

The lubrication system of any one or more of the embodiments, further comprising a motor assembly in mechanical communication with the chain to drive rotation thereof; and a one-way ratchet in mechanical communication between the motor assembly and the chain to maintain uni-directional rotation of the chain.

The lubrication system of any one or more of the embodiments, further comprising an intermediate worm gear disposed in mechanical communication between the motor assembly and the pump rotor.

The lubrication system of any one or more of the embodiments, further comprising a motor assembly in mechanical communication with the chain to drive rotation thereof; and a pump motor spaced apart from the motor assembly and in mechanical motivation with the pump rotor to drive rotation thereof.

This written description uses examples to disclose the present application, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims. While the primary embodiments described herein are directed to chainsaw-type tools, other tools are also expressly included.

What is claimed is:

1. A tool comprising:
a housing;
a motor assembly attached to the housing;
a tool unit powered by the motor assembly, the tool unit comprising a guide bar and a chain circumscribing a portion of the guide bar; and
a lubrication system to provide lubricant to the chain, the lubrication system comprising:
a lubricant reservoir to contain a volume of the lubricant,
a lubricant output directed toward the guide bar in fluid communication with the lubricant reservoir, and
a reversible lubricant pump disposed in fluid communication between the lubricant reservoir and the lubricant output to alternately motivate a first lubricant flow from the lubricant reservoir and a second lubricant flow to the lubricant reservoir.

2. The tool of claim 1, wherein the reversible lubricant pump is mounted above the motor assembly.

3. The tool of claim 1, wherein the lubrication system further comprises
one or more conduits defining a lubricant flow path between the lubricant reservoir and the lubricant output, and
a pump rotor rotatably disposed along the lubricant flow path to alternately motivate the first lubricant flow and the second lubricant flow.

4. The tool of claim 3, wherein the pump rotor comprises a peristaltic rotor disposed outside of the lubricant flow path on the one or more conduits.

5. The tool of claim 3, wherein the pump rotor is in mechanical communication with the motor assembly.

6. The tool of claim 5, further comprising a one-way ratchet in mechanical communication between the motor assembly and the tool unit to maintain uni-directional rotation of the chain.

7. The tool of claim 5, further comprising an intermediate worm gear disposed in mechanical communication between the motor assembly and the pump rotor.

8. The tool of claim 3, wherein the lubrication system further comprises a pump motor spaced apart from the motor assembly and in mechanical motivation with the pump rotor to drive rotation thereof.

9. The tool of claim 1, further comprising a controller in operable communication with the motor assembly and lubrication system and configured to direct an oil-retention operation, the oil-retention operation comprising:
directing chain rotation at the motor assembly,
motivating the first lubricant flow during chain rotation,
halting chain rotation,
receiving a reversal signal when or following halting chain rotation, and
motivating the second lubricant flow in response to receiving the reversal signal.

10. The tool of claim 9, further comprising a reversal user input in operable communication with the controller and supported on the housing apart from the motor assembly, wherein the reversal signal is received from the reversal user input.

11. The tool of claim 9, wherein the reversal signal is received in response to halting chain rotation.

12. A method of operating a tool comprising a motor assembly, a tool unit powered by the motor assembly, the tool unit comprising a guide bar and a chain circumscribing a portion of the guide bar, a lubricant reservoir, a lubricant output directed toward the guide bar in fluid communication with the lubricant reservoir, and a reversible lubricant pump disposed in fluid communication between the lubricant reservoir and the lubricant output, the method comprising:
directing chain rotation at the motor assembly;
motivating a first lubricant flow from the lubricant reservoir during chain rotation;
halting chain rotation;
receiving a reversal signal when or following halting chain rotation; and
motivating a second lubricant flow to the lubricant reservoir in response to receiving the reversal signal.

13. The method of claim 12, wherein the tool further comprises a reversal user input, wherein the reversal signal is received from the reversal user input.

14. The method of claim 12, wherein the reversal signal is received in response to halting chain rotation.

15. A lubrication system of a tool comprising a guide bar and a chain circumscribing a portion of the guide bar, the lubrication system comprising:
a lubricant reservoir to contain a volume of lubricant;
a lubricant output directed toward the guide bar;
one or more conduits defining a lubricant flow path between the lubricant reservoir and the lubricant output; and
a reversible lubricant pump disposed in fluid communication between the lubricant reservoir and the lubricant output, the reversible lubricant pump comprising a pump rotor to alternately motivate a first lubricant flow from the lubricant reservoir and a second lubricant flow to the lubricant reservoir.

16. The lubrication system of claim 15, wherein the pump rotor comprises a peristaltic rotor disposed outside of the lubricant flow path on the one or more conduits.

17. The lubrication system of claim 15, wherein the pump rotor is in mechanical communication with a motor assembly configured to drive rotation of a chain.

18. The lubrication system of claim 17, further comprising
a motor assembly in mechanical communication with the chain to drive rotation thereof; and
a one-way ratchet in mechanical communication between the motor assembly and the chain to maintain uni-directional rotation of the chain.

19. The lubrication system of claim 18, further comprising an intermediate worm gear disposed in mechanical communication between the motor assembly and the pump rotor.

20. The lubrication system of claim 17, further comprising
a motor assembly in mechanical communication with the chain to drive rotation thereof; and
a pump motor spaced apart from the motor assembly and in mechanical motivation with the pump rotor to drive rotation thereof.
